(19) United States
(12) Patent Application Publication
(10) Pub. No.: US 2022/0372884 A1
(43) Pub. Date: Nov. 24, 2022

(54) PRELOAD SLEEVE FOR A COLLET-MOUNTED BLADE DOVETAIL

(71) Applicants: General Electric Company, Schenectady, NY (US); General Electric Company Polska sp. z o.o., Warsaw (PL)

(72) Inventors: Nicholas J. Kray, Evendale, OH (US); Nicholas M. Daggett, Evendale, OH (US); Frank Worthoff, Evendale, OH (US); Damian Osowski, Warsaw (PL)

(21) Appl. No.: 17/328,706

(22) Filed: May 24, 2021

(51) Int. Cl. F01D 5/32

(52) U.S. Cl. CPC F01D 5/32; F05D 2220/32

(57) ABSTRACT

Preload sleeves and/or other retainers for a collet-mounted blade dovetail and/or other root are disclosed. An example turbofan for an engine includes a trunnion forming a socket for a root of a blade, a primary collet positioning the root with respect to the trunnion, and a radial preload retainer at least partially encircling the primary collet and applying a radial force with respect to the primary collet to support the primary collet positioning the root with respect to the trunnion.

### FIELD OF THE DISCLOSURE

This disclosure relates generally to blade retention, and more particularly, to a preload sleeve for a collet-mounted blade dovetail.

### BACKGROUND

In recent years, turbine engines have been increasingly utilized in a variety of applications and fields. Turbine engines are intricate machines with extensive availability, reliability, and serviceability requirements. Turbine engines include fan blades. The fan blades spin at high speed and subsequently compress the air flow. The high-pressure compressor then feeds the pressurized air flow to a combustion chamber to generate a high-temperature, high-pressure gas stream. In operation, various forces act on the blades and can cause the blades to become unseated and/or otherwise unsuitable for continued operation in the engine.

### BRIEF SUMMARY

Methods, apparatus, systems, and articles of manufacture corresponding to a preload retainer for a collet-mounted blade dovetail or root are disclosed.

Certain examples provide an engine. The example engine includes a trunnion forming a socket for a root of a blade, a primary collet positioning the root with respect to the trunnion, and a radial preload retainer at least partially encircling the primary collet and applying a radial force with respect to the primary collet to support the primary collet positioning the root with respect to the trunnion.

Certain examples provide a rotor assembly for a blades of an engine. The example rotor includes a primary collet positioning a root of a blade with respect to a trunnion, the trunnion forming a socket for the root, and a radial preload retainer encircling the primary collet and applying a radial force with respect to the primary collet to support the primary collet positioning the root with respect to the trunnion.

Certain examples provide a blade retention apparatus. The example blade retention apparatus includes a means for forming a socket for a root of a blade, a means for positioning the root in the socket, for positioning and applying a radial force with respect to the means for positioning to maintain the root in the socket.

### BRIEF DESCRIPTION OF THE DRAWINGS

FIG. 1A illustrates an example cross-section view of an example turbofan gas turbine engine.

FIG. 1B illustrates an example cross-section view of an example open rotor engine.

FIG. 2 illustrates a cross-section of an example blade and socket configuration including a spanner nut preloading retainer.

FIG. 3 illustrates another example view of the spanner nut preloading retainer of FIG. 2.

FIG. 4 illustrates a cross-section of an example blade and socket configuration including a ram loading preloading retainer.

FIG. 5 illustrates another example view of the ram loading preloading retainer of FIG. 4.

FIG. 6 illustrates a cross-section of an example blade and socket configuration including a primary collet preloading retainer.

FIG. 7 illustrates another example view of the primary collet preloading retainer of FIG. 6.

FIG. 8 illustrates a cross-section of an example blade and socket configuration including a belt device preloading retainer.

FIG. 9 illustrates another example view of the belt device preloading retainer of FIG. 8.

FIG. 10 illustrates a cross-section of an example blade and socket configuration including a split collet with a double conical root preloading retainer.

FIG. 11 illustrates another example view of the split collet with the double conical root preloading retainer of FIG. 10.

The figures are not to scale. Instead, the thickness of regions may be enlarged in the drawings. In general, the same reference numbers will be used throughout the drawing(s) and accompanying written description to refer to the same or like parts. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. Stating that any part is in “contact” and/or “direct contact” with another part means that there is no intermediate part between the two parts.

Descriptors “first,” “second,” “third,” etc. are used herein when identifying multiple elements or components which may be referred to separately. Unless otherwise specified or understood based on their context of use, such descriptors are not intended to impute any meaning of priority, physical order, or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

### DETAILED DESCRIPTION

Aircrafts include engines that act as a propulsion system to generate mechanical power and forces such as thrust. A gas turbine, also called a combustion turbine or a turbine engine, is a type of external combustion engine that can be implemented in the propulsion system of an aircraft. For example, a gas turbine can be implemented in connection with a turbofan, a turbojet, an open rotor, and/or other aircraft engine. Gas turbines also have significant applications in areas such as industrial power generation.

In the following detailed description, reference is made to the accompanying drawings that form a part hereof, and in which is shown by way of illustration specific examples that may be practiced. These examples are described in sufficient detail to enable one skilled in the art to practice the subject matter, and it is to be understood that other examples may be utilized. The following detailed description is therefore, provided to describe example implementations and not to be taken limiting on the scope of the subject matter described in this disclosure. Certain features from different aspects of the following description may be combined to form yet new aspects of the subject matter discussed below.

When introducing elements of various embodiments of the present disclosure, the articles “a,” “an,” “the,” and “said” are intended to mean that there are one or more of the elements. The terms “first,” “second,” and the like, do not denote any order, quantity, or importance, but rather are used to distinguish one element from another. The terms “comprising,” “including,” and “having” are intended to be inclusive and mean that there may be additional elements other than the listed elements. As the terms “connected to,” “coupled to,” etc. are used herein, one object (e.g., a material, element, structure, member, etc.) can be connected to or coupled to another object regardless of whether the one object is directly connected or coupled to the other object or whether there are one or more intervening objects between the one object and the other object.

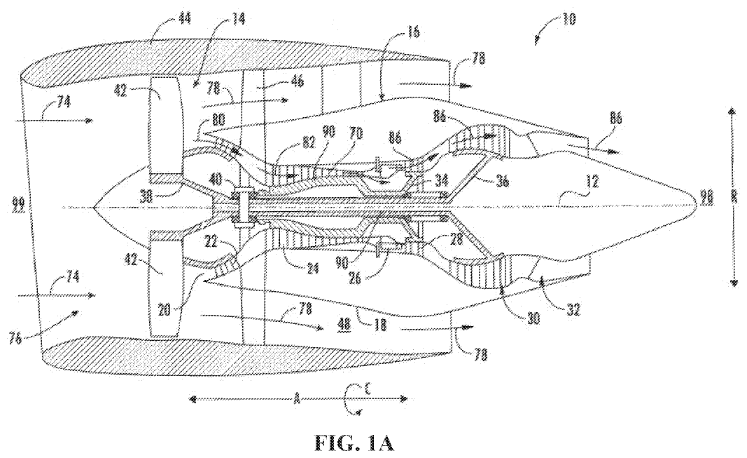

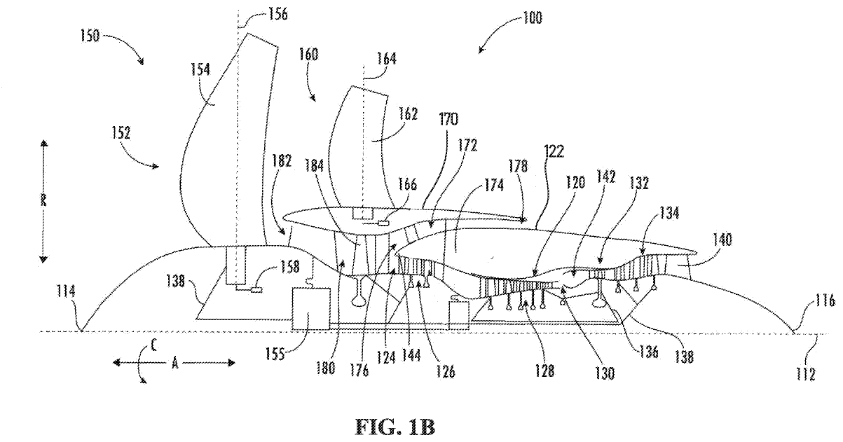

The terms “upstream” and “downstream” refer to the relative direction with respect to fluid flow in a fluid pathway. For example, “upstream” refers to the direction from which the fluid flows, and “downstream” refers to the direction to which the fluid flows. As used herein, “vertical” refers to the direction perpendicular to the ground. As used herein, “horizontal” refers to the direction parallel to the centerline of the gas turbine engine 100. As used herein, “lateral” refers to the direction perpendicular to the axial and vertical directions (e.g., into and out of the plane of FIGS. 1A-1B, etc.).

In some examples used herein, the term “substantially” is used to describe a relationship between two parts that is within three degrees of the stated relationship (e.g., a substantially colinear relationship is within three degrees of being linear, a substantially perpendicular relationship is within three degrees of being perpendicular, a substantially parallel relationship is within three degrees of being parallel, etc.).

As used herein, the terms “axial” and “longitudinal” both refer to a direction parallel to the centerline axis of a gas turbine (e.g., a turbofan, a core gas turbine engine, etc.), while “radial” refers to a direction perpendicular to the axial direction, and “tangential” or “circumferential” refers to a direction mutually perpendicular to the axial and radial directions. Accordingly, as used herein, “radially inward” refers to the radial direction from the outer circumference of the gas turbine towards the centerline axis of the gas turbine, and “radially outward” refers to the radial direction from the centerline axis of the gas turbine towards the outer circumference of gas turbine. As used herein, the terms “forward”, “fore”, and “front” refer to a location relatively upstream in an air flow passing through or around a component, and the terms “aft” and “rear” refer to a location relatively downstream in an air flow passing through or around a component.

The basic operation of a gas turbine implemented in connection with a turbofan engine of a propulsion system of an aircraft includes an intake of fresh atmospheric air flow through the front of the turbofan engine with a fan. In the operation of a turbofan engine, a first portion of the intake air bypasses a core gas turbine engine of the turbofan to produce thrust directly. A second portion of the intake air travels through a booster compressor (e.g., a first compressor) located between the fan and a high-pressure compressor (e.g., a second compressor) in the core gas turbine engine (e.g., the gas turbine). The booster compressor is used to raise or boost the pressure of the second portion of the intake air prior to the air flow entering the high-pressure compressor. The air flow can then travel through the high-pressure compressor that further pressurizes the air flow. The booster compressor and the high-pressure compressor each include a group of blades attached to a rotor and/or shaft. The blades spin at high speed relative to stationary vanes and each rotation of the blades subsequently compresses the air flow. The high-pressure compressor then feeds the pressurized air flow to a combustion chamber (e.g., combustor). In some examples, the high-pressure compressor feeds the pressurized air flow at speeds of hundreds of miles per hour. In some instances, the combustion chamber includes one or more rings of fuel injectors that inject a steady stream of fuel into the combustion chamber, where the fuel mixes with the pressurized air flow. A secondary use of the compressors, particularly the high-pressure compressor, is to bleed air for use in other systems of the aircraft (e.g., cabin pressure, heating, and air conditioning, etc.)

In the combustion chamber of the core gas turbine engine, the fuel is ignited with an electric spark provided by an igniter, where the fuel in some examples burns at temperatures of more than 2000 degrees Fahrenheit. The resulting combustion produces a high-temperature, high-pressure gas stream (e.g., hot combustion gas) that passes through another group of blades called a turbine. The turbine can include a low-pressure turbine and a high-pressure turbine, for example. Each of the low-pressure turbine and the high-pressure turbine includes an intricate array of alternating rotating blades and stationary airfoil-section blades (e.g., vanes). The high-pressure turbine is located axially downstream from the combustor and axially upstream from the low-pressure turbine. As the hot combustion gas passes through the turbine, the hot combustion gas expands through the blades and/or vanes, causing the rotating blades coupled to rotors of the high-pressure turbine and the low-pressure turbine to spin.

The rotating blades of the high-pressure turbine and the low-pressure turbine serve at least two purposes. A first purpose of the rotating blades is to drive the fan, the high-pressure compressor, and/or the booster compressor to draw more pressured air into the combustion chamber. For example, in a dual-spool design of a turbofan, the low-pressure turbine (e.g., a first turbine) can be attached to and in force transmitting connection with the booster compressor (e.g., the first compressor) and fan via a first shaft, collectively a first spool of the gas turbine, such that the rotation of a rotor of the low-pressure turbine drives a rotor of the booster compressor and the fan. For example, a high-pressure turbine (e.g., a second turbine) can be attached to and in force transmitting connection with the high-pressure compressor (e.g., a second compressor) via a second shaft coaxial with the first shaft, collectively a second spool of the gas turbine, such that the rotation of a rotor of the high-pressure turbine drives a rotor of the high-pressure compressor. A second purpose of the rotating blades is to spin a generator operatively coupled to the turbine section to produce electricity. For example, the turbine can generate electricity to be used by an aircraft, a power station, etc.

It is generally an object of the design of aircraft engines such as turbofans to compress as much air as is feasible within the compressor of the core gas turbine engine given the static, dynamic, centrifugal and/or thermal stress limitations and weight considerations of aspects of the core gas turbine engine and/or the turbofan engine. A metric defining the compressive action of a compressor is a compression ratio (e.g., pressure ratio) of a compressor. The compression ratio of a compressor of a turbofan engine is the ratio of pressure at an outlet of the compressor (e.g., the outlet of the high-pressure compressor at the combustion chamber of the gas turbine) to pressure at an inlet of a fan. A higher compression ratio increases a thermal efficiency of the turbine engine and decreases a specific fuel consumption of the turbine engine (e.g., a ratio of air to fuel used to create thrust produced by the jet engine). Thus, an increase in the compression ratio of the compressor of a gas turbine can increase thrust produced by a jet engine, such as a turbofan, etc., and/or can increase fuel efficiency of the jet engine. In turn, it is an object of gas turbine design to minimize or otherwise reduce pressure losses through the compressors to maximize or otherwise improve the compression ratio. Though examples disclosed herein are discussed in connection with a turbofan jet engine, it is understood that examples disclosed herein can be implemented in connection with a turbojet jet engine, a turboprop jet engine, a combustion turbine for power production, or any other suitable application where it is desired to increase compression ratios across one or more compressors.

The example low-pressure compressor and high-pressure compressor of the turbine engine of the turbofan each include one or more stages. Each stage includes an annular array of compressor blades (e.g., first airfoils) mounted about a central rotor paired with an annular array of stationary compressor vanes (e.g., second airfoils) spaced apart from the rotor and fixed to a casing of the compressor. At an aft portion of a compressor stage, rotation of the rotor and accompanying blades provides an increase in velocity, temperature, and pressure of air flow. At a fore portion of the compressor stage, the air flow diffuses (e.g., loses velocity) across compressor vanes providing for an increase in pressure. The implementation of multiple stages across the low-pressure compressor and high-pressure compressor provides for the compression ratios to operate a jet engine such as a turbofan.

In the example of the high-pressure compressor and the low-pressure compressor, compressor blades (also referred to herein as blades and/or dovetail blades) are arrayed about a corresponding high-pressure compressor rotor and low-pressure compressor rotor, respectively. The high-pressure rotor and accompanying compressor blades (e.g., blades, dovetail blades, etc.) can be fashioned from titanium alloys (e.g., a titanium-aluminum alloy, a titanium-chromium alloy, etc.) and/or steel alloys (e.g., a steel-chromium alloy), etc. For example, to increase ease of maintenance and assembly, replaceability of blades, and/or modularity of the high-pressure compressor, discrete compressor blades are mounted in series annularly about the high-pressure rotor to achieve a substantially uniform distribution annularly about the rotor. For this purpose, an example compressor blade implemented in accordance with the teachings of this disclosure includes an airfoil portion and a mounting portion. The airfoil portion of the compressor blade causes the velocity, pressure, and temperature increase to the air flow. The mounting portion of the compressor blade enables mounting of blade to the rotor. In some examples, the geometry of the airfoil portion and/or mounting portion can be different for the compressor blades of each stage of the high-pressure compressor and the same for the compressor blades within each stage of the high-pressure compressor.

In certain examples, the mounting portion of the example compressor blade includes a dovetail protrusion and a platform. In this example, the high-pressure compressor rotor is provided at each stage with a dovetail slot (e.g., also referred to herein as a slot) to receive the dovetail protrusions of a plurality of blades of the stage. For example, a compressor blade can be in a mounted state with a high-pressure rotor when the dovetail slot of the high-pressure compressor rotor receives the dovetail protrusion of the compressor blade. In this example, the dovetail protrusion of the blade defines a radially outer portion (e.g., a portion relatively radially outward when mounted) and a radially inner portion (e.g., a portion relatively radially inward when mounted). In this example, the radially outer portion is relatively less in axial length (e.g., when mounted, the length in the axial direction of the turbine engine and/or compressor) than the radially inner portion. The dovetail slot also includes a radially outer portion and a radially inner portion. For example, the radially outer portion can include a pair of annular flanges (e.g., a neck, a first neck, etc.) extending axially towards the center of the dovetail slot. The dimensions of the compressor blade and the dovetail slot are such that when the compressor blade is in a mounted state with the compressor blade, the annular flanges (e.g., a neck) of the dovetail slot interfere with the radially inner portion of the compressor blade, thereby retaining the compressor blade from radially outward movement.

Traditionally, a plurality of compressor blades of a stage are mounted annularly in respective dovetail slots aligned in series such that the platform of each blade interfaces with the platform of a first subsequent blade on a first circumferential side and interfaces with the platform of a second subsequent blade on a second circumferential side.

Though examples disclosed herein are discussed in connection with dovetail slots of a rotor of a high-pressure compressor of a core gas turbine engine of a turbofan engine, other examples can be implemented in accordance with the teachings of the present disclosure for a low-pressure compressor, an intermediate-pressure compressor, a sole compressor of a single spool gas turbine, a compressor with an alternative slot design, a compressor of a gas turbine for industrial power production, a turbine rotor and/or any other suitable application.

A challenge for an open rotor engine is to create a secure loading mechanism to retain blades in their slots. Using a type of loading not present on conventional turbo fans, certain examples provide a preload sleeve and/or other preload mechanism (also referred to herein as a preload retainer) to apply a radial load to a blade's axial dovetail in a collet fixture. The preload retainer adds a radial preload to the collet and/or other blade-retaining apparatus to assist in maintaining blade seating in its respective slot or socket (e.g., formed by the collet and a trunnion, etc.) during operation of the engine. Certain examples do not rely on high centrifugal loading of the blade into the dovetail slot to maintain seating. In instances of low revolutions per minute (rpm), loading a blade in a dovetail slot involves a preloading approach that clamps down on the blade to keep the blade seated. Examples disclosed and described herein provide various locking or securing preload retainers to keep a rotor blade in an engine slot.

Advantages to these configurations include keeping a blade loaded in a dovetail slot such as in instances of low rpm, where proper seating of the blade in the slot is reduced and an excitation force may be high such as in propeller or open-rotor applications. In propeller or open-rotor engine applications, for example, a high vibratory load is experienced during various phases of the flight due to asymmetric propeller loading (e.g., P-Factor or 1P loading). 1P loading, also referred to as +/−1P loading, refers to movement or force on a blade caused by a blade's excitation frequency relative to rotor revolution, which often occurs during takeoff rotation. Certain examples address +/−1P loading by applying a radial preload to the blade assembly that provides better blade retention and allows for better serviceability.

Further, existing turboprop or open rotor technology requires that when there is a failure of a blade, the single blade cannot be removed. Instead, a complex disassembly process must be completed to remove a single fan blade, which increases the time and work required to service the equipment. In contrast, certain examples enable blades to individually be retained and removed from a blade assembly for servicing, repair, replacement, etc.

In certain configurations, a gas turbine engine includes a preload sleeve and/or other radial preload retainer to secure a collet-mounted blade dovetail such as a rotor blade, etc. The rotor blade ends in a root, which can be shaped in one or more configurations such as a dovetail, conical root, split root, etc. The root (also referred to herein as a tang or dovetail root) is positioned in a socket formed by a trunnion and held in place by a collet. A trunnion is cylindrical shaft that can position and support an object, such as the root of the blade. The trunnion holds the root in place using the collet, further secured by a preload sleeve and/or other preload retainer. A collet forms a collar around the root of the blade to hold the root and exert a clamping force around the root. In certain examples, the collet can be a rotatable collet, for example, and the blade can be a composite airfoil, for example.

Example preload retaining mechanisms can be applied to both closed and open rotor engine designs. For purposes of illustration only, FIG. 1A illustrates an example closed-rotor turbofan engine, and FIG. 1B illustrates an example open-rotor engine.

FIG. 1A illustrates an example cross-section view of a turbofan gas turbine engine in which a radial preload retainer can be used to retain blades in a trunnion or other socket. Referring now to the drawings, FIG. 1A is a schematic partially cross-sectioned side view of an exemplary gas turbine engine 10 as may incorporate various examples of the present invention. The engine 10 may particularly be configured as a gas turbine engine for an aircraft. Although further described herein as a turbofan engine, the engine 10 may define a turboshaft, turboprop, or turbojet gas turbine engine, including marine and industrial engines and auxiliary power units. As shown in FIG. 1A, the engine 10 has a longitudinal or axial centerline axis 12 that extends therethrough for reference purposes. An axial direction A is extended co-directional to the axial centerline axis 12 for reference. The engine 10 further defines an upstream end 99 and a downstream end 98 for reference. In general, the engine 10 may include a fan assembly 14 and a core engine 16 disposed downstream from the fan assembly 14. For reference, the engine 10 defines an axial direction A, a radial direction R, and a circumferential direction C. In general, the axial direction A extends parallel to the axial centerline 12, the radial direction R extends outward from and inward to the axial centerline 12 in a direction orthogonal to the axial direction A, and the circumferential direction extends three hundred sixty degrees (360°) around the axial centerline 12.

The core engine 16 may generally include a substantially tubular outer casing 18 that defines an annular inlet 20. The outer casing 18 encases or at least partially forms, in serial flow relationship, a compressor section having a booster or low pressure (LP) compressor 22, a high pressure (HP) compressor 24, a heat addition system 26, an expansion section or turbine section including a high pressure (HP) turbine 28, a low pressure (LP) turbine 30 and a jet exhaust nozzle section 32. A high pressure (HP) rotor shaft 34 drivingly connects the HP turbine 28 to the HP compressor 24. A low pressure (LP) rotor shaft 36 drivingly connects the LP turbine 30 to the LP compressor 22. The LP rotor shaft 36 may also be connected to a fan shaft 38 of the fan assembly 14. In certain examples, as shown in FIG. 1A, the LP rotor shaft 36 may be connected to the fan shaft 38 via a reduction gear 40 such as in an indirect-drive or geared-drive configuration.

As shown in FIG. 1A, the fan assembly 14 includes a plurality of fan blades 42 that are coupled to and that extend radially outwardly from the fan shaft 38. An annular fan casing or nacelle 44 circumferentially may surround the fan assembly 14 and/or at least a portion of the core engine 16. It should be appreciated by those of ordinary skill in the art that the nacelle 44 may be configured to be supported relative to the core engine 16 by a plurality of circumferentially-spaced outlet guide vanes or struts 46. Moreover, at least a portion of the nacelle 44 may extend over an outer portion of the core engine 16 so as to define a fan flow passage 48 therebetween. However, it should be appreciated that various configurations of the engine 10 may omit the nacelle 44, or omit the nacelle 44 from extending around the fan blades 42, such as to provide an open rotor or propfan configuration of the engine 10 depicted in FIG. 1B.

It should be appreciated that combinations of the shafts 34, 36, the compressors 22, 24, and the turbines 28, 30 define a rotor assembly 90 of the engine 10. For example, the HP shaft 34, HP compressor 24, and HP turbine 28 may define a high speed or HP rotor assembly of the engine 10. Similarly, combinations of the LP shaft 36, LP compressor 22, and LP turbine 30 may define a low speed or LP rotor assembly of the engine 10. Various examples of the engine 10 may further include the fan shaft 38 and fan blades 42 as the LP rotor assembly. In certain examples, the engine 10 may further define a fan rotor assembly at least partially mechanically de-coupled from the LP spool via the fan shaft 38 and the reduction gear 40. Still further examples may further define one or more intermediate rotor assemblies defined by an intermediate pressure compressor, an intermediate pressure shaft, and an intermediate pressure turbine disposed between the LP rotor assembly and the HP rotor assembly (relative to serial aerodynamic flow arrangement).

During operation of the engine 10, a flow of air, shown schematically by arrows 74, enters an inlet 76 of the engine 10 defined by the fan case or nacelle 44. A portion of air, shown schematically by arrow 80, enters the core engine 16 through a core inlet 20 defined at least partially via the outer casing 18. The flow of air is provided in serial flow through the compressors, the heat addition system, and the expansion section via a core flowpath 70. The flow of air 80 is increasingly compressed as it flows across successive stages of the compressors 22, 24, such as shown schematically by arrows 82. The compressed air 82 enters the heat addition system 26 and mixes with a liquid and/or gaseous fuel and is ignited to produce combustion gases 86. It should be appreciated that the heat addition system 26 may form any appropriate system for generating combustion gases, including, but not limited to, deflagrative or detonative combustion systems, or combinations thereof. The heat addition system 26 may include annular, can, can-annular, trapped vortex, involute or scroll, rich burn, lean burn, rotating detonation, or pulse detonation configurations, or combinations thereof.

The combustion gases 86 release energy to drive rotation of the HP rotor assembly and the LP rotor assembly before exhausting from the jet exhaust nozzle section 32. The release of energy from the combustion gases 86 further drives rotation of the fan assembly 14, including the fan blades 42. A portion of the air 74 bypasses the core engine 16 and flows across the fan flow passage 48, such as shown schematically by arrows 78.

It should be appreciated that FIG. 1A depicts and describes a two-stream engine having the fan flow passage 48 and the core flowpath 70. The example depicted in FIG. 1A has a nacelle 44 surrounding the fan blades 42, such as to provide noise attenuation, blade-out protection, and other benefits known for nacelles, and which may be referred to herein as a “ducted fan,” or the entire engine 10 may be referred to as a “ducted engine.”

FIG. 1B provides a schematic cross-sectional view of an example open-rotor turbine engine according to one example of the present disclosure. Particularly, FIG. 1B provides an aviation three-stream turbofan engine herein referred to as “three-stream engine 100”. The three-stream engine 100 of FIG. 1B can be mounted to an aerial vehicle, such as a fixed-wing aircraft, and can produce thrust for propulsion of the aerial vehicle. The architecture of the three-stream engine 100 provides three distinct streams of thrust-producing airflow during operation. Unlike the engine 10 shown in FIG. 1A, the three-stream engine 100 includes a fan that is not ducted by a nacelle or cowl, such that it may be referred to herein as an “unducted fan,” or the entire engine 100 may be referred to as an “unducted engine.”

For reference, the three-stream engine 100 defines an axial direction A, a radial direction R, and a circumferential direction C. Moreover, the three-stream engine 100 defines an axial centerline or longitudinal axis 112 that extends along the axial direction A. In general, the axial direction A extends parallel to the longitudinal axis 112, the radial direction R extends outward from and inward to the longitudinal axis 112 in a direction orthogonal to the axial direction A, and the circumferential direction extends three hundred sixty degrees (360°) around the longitudinal axis 112. The three-stream engine 100 extends between a forward end 114 and an aft end 116, e.g., along the axial direction A.

The three-stream engine 100 includes a core engine 120 and a fan section 150 positioned upstream thereof. Generally, the core engine 120 includes, in serial flow order, a compressor section, a combustion section, a turbine section, and an exhaust section. Particularly, as shown in FIG. 1B, the core engine 120 includes a core cowl 122 that defines an annular core inlet 124. The core cowl 122 further encloses a low pressure system and a high pressure system. In certain examples, the core cowl 122 may enclose and support a booster or low pressure (“LP”) compressor 126 for pressurizing the air that enters the core engine 120 through core inlet 124. A high pressure (“HP”), multi-stage, axial-flow compressor 128 receives pressurized air from the LP compressor 126 and further increases the pressure of the air. The pressurized air stream flows downstream to a combustor 130 where fuel is injected into the pressurized air stream and ignited to raise the temperature and energy level of the pressurized air. It will be appreciated that as used herein, the terms “high/low speed” and “high/low pressure” are used with respect to the high pressure/high speed system and low pressure/low speed system interchangeably. Further, it will be appreciated that the terms “high” and “low” are used in this same context to distinguish the two systems, and are not meant to imply any absolute speed and/or pressure values.

The high energy combustion products flow from the combustor 130 downstream to a high pressure turbine 132. The high pressure turbine 132 drives the high pressure compressor 128 through a high pressure shaft 136. In this regard, the high pressure turbine 132 is drivingly coupled with the high pressure compressor 128. The high energy combustion products then flow to a low pressure turbine 134. The low pressure turbine 134 drives the low pressure compressor 126 and components of the fan section 150 through a low pressure shaft 138. In this regard, the low pressure turbine 134 is drivingly coupled with the low pressure compressor 126 and components of the fan section 150. The LP shaft 138 is coaxial with the HP shaft 136 in this example. After driving each of the turbines 132, 134, the combustion products exit the core engine 120 through a core exhaust nozzle 140 to produce propulsive thrust. Accordingly, the core engine 120 defines a core flowpath or core duct 142 that extends between the core inlet 124 and the core exhaust nozzle 140. The core duct 142 is an annular duct positioned generally inward of the core cowl 122 along the radial direction R.

The fan section 150 includes a fan 152, which is the primary fan in this example. For the depicted example of FIG. 1B, the fan 152 is an open rotor or unducted fan. However, in other examples, the fan 152 may be ducted, e.g., by a fan casing or nacelle circumferentially surrounding the fan 152. As depicted, the fan 152 includes an array of fan blades 154 (only one shown in FIG. 1B). The fan blades 154 are rotatable, e.g., about the longitudinal axis 112. As noted above, the fan 152 is drivingly coupled with the low pressure turbine 134 via the LP shaft 138. The fan 152 can be directly coupled with the LP shaft 138, e.g., in a direct-drive configuration. Optionally, as shown in FIG. 1B, the fan 152 can be coupled with the LP shaft 138 via a speed reduction gearbox 155, e.g., in an indirect-drive or geared-drive configuration.

Moreover, the fan blades 154 can be arranged in equal spacing around the longitudinal axis 112. Each blade 154 has a root and a tip and a span defined therebetween. Each blade 154 defines a central blade axis 156. For this example, each blade 154 of the fan 152 is rotatable about its respective central blade axes 156, e.g., in unison with one another. One or more actuators 158 can be controlled to pitch the blades 154 about their respective central blade axes 156. However, in other examples, each blade 154 may be fixed or unable to be pitched about its central blade axis 156.

The fan section 150 further includes a fan guide vane array 160 that includes fan guide vanes 162 (only one shown in FIG. 1B) disposed around the longitudinal axis 112. For this example, the fan guide vanes 162 are not rotatable about the longitudinal axis 112. Each fan guide vane 162 has a root and a tip and a span defined therebetween. The fan guide vanes 162 may be unshrouded as shown in FIG. 1B or may be shrouded, e.g., by an annular shroud spaced outward from the tips of the fan guide vanes 162 along the radial direction R. Each fan guide vane 162 defines a central blade axis 164. For this example, each fan guide vane 162 of the fan guide vane array 160 is rotatable about its respective central blade axes 164, e.g., in unison with one another. One or more actuators 166 can be controlled to pitch the fan guide vane 162 about their respective central blade axes 164. However, in other examples, each fan guide vane 162 may be fixed or unable to be pitched about its central blade axis 164. The fan guide vanes 162 are mounted to a fan cowl 170.

As shown in FIG. 1B, in addition to the fan 152, which is unducted, a ducted fan 184 is included aft of the fan 152, such that the three-stream engine 100 includes both a ducted and an unducted fan that both serve to generate thrust through the movement of air without passage through core engine 120. The ducted fan 184 is shown at about the same axial location as the fan guide vane 162, and radially inward of the fan guide vane 162. Alternatively, the ducted fan 184 may be between the fan guide vane 162 and core duct 142, or be farther forward of the fan guide vane 162. The ducted fan 184 may be driven by the low pressure turbine 134 (e.g., coupled to the LP shaft 138), or by any other suitable source of rotation, and may serve as the first stage of booster or may be operated separately.

The fan cowl 170 annularly encases at least a portion of the core cowl 122 and is generally positioned outward of the core cowl 122 along the radial direction R. Particularly, a downstream section of the fan cowl 170 extends over a forward portion of the core cowl 122 to define a fan flowpath or fan duct 172. Incoming air may enter through the fan duct 172 through a fan duct inlet 176 and may exit through a fan exhaust nozzle 178 to produce propulsive thrust. The fan duct 172 is an annular duct positioned generally outward of the core duct 142 along the radial direction R. The stationary struts 174 may each be aerodynamically contoured to direct air flowing thereby. Other struts in addition to the stationary struts 174 may be used to connect and support the fan cowl 170 and/or core cowl 122. In many examples, the fan duct 172 and the core duct 122 may at least partially co-extend (generally axially) on opposite sides (e.g., opposite radial sides) of the core cowl 122. For example, the fan duct 172 and the core duct 122 may each extend directly from the leading edge 144 of the core cowl 122 and may partially co-extend generally axially on opposite radial sides of the core cowl.

The three-stream engine 100 also defines or includes an inlet duct 180. The inlet duct 180 extends between an engine inlet 182 and the core inlet 124/fan duct inlet 176. The engine inlet 182 is defined generally at the forward end of the fan cowl 170 and is positioned between the fan 152 and the array of fan guide vanes 160 along the axial direction A. The inlet duct 180 is an annular duct that is positioned inward of the fan cowl 170 along the radial direction R. Air flowing downstream along the inlet duct 180 is split, not necessarily evenly, into the core duct 142 and the fan duct 172 by a splitter or leading edge 144 of the core cowl 122. The inlet duct 180 is wider than the core duct 142 along the radial direction R. The inlet duct 180 is also wider than the fan duct 172 along the radial direction R.

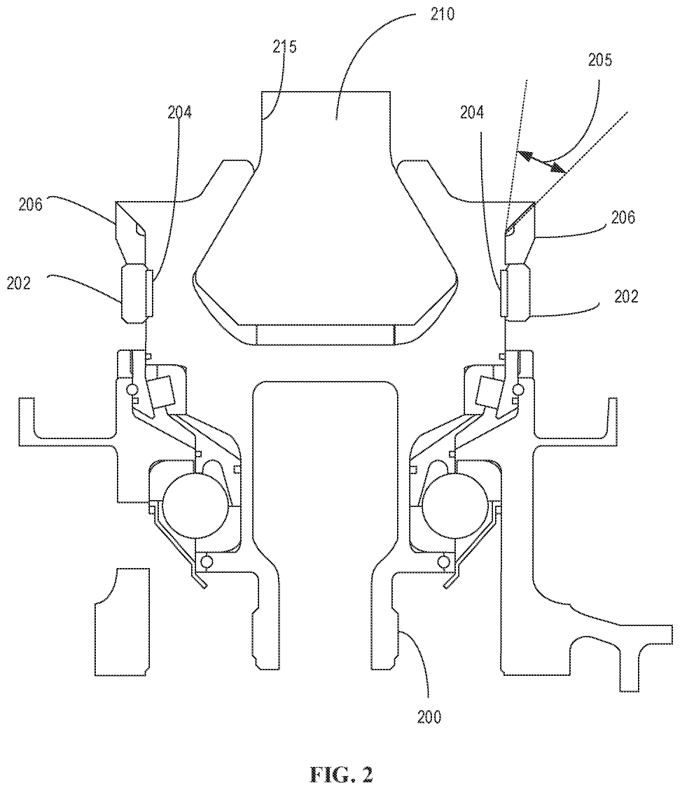

As discussed above, one or more preloading retainers, such as a radial preload sleeve, etc., can be used to retain blades, such as blades of the example engine 100, in their sockets. FIG. 2 illustrates a cross-section of an example blade and socket configuration including spanner nut preloading retainer. This example configuration includes a rotor blade 215. The rotor blade ends in a root 210, which can be shaped in multiple configurations such as a dovetail as illustrated. The root 210 is held in place inside the trunnion 200, which is a shaft or receptacle forming a socket to position and support the root 210. A primary collet 206, shown in the example cross-section of FIG. 2, encircles the trunnion 200 to hold the root 210 in place. Additionally, the example of FIG. 2 includes a spanner nut 202.

As shown in the example cross-section of FIG. 2, the spanner nut 202 encircles the threaded retainer collet 204. The threaded retainer collet 204 surrounds the trunnion 200. The spanner nut 202 exerts an upward force against a primary collet 206. In the example of FIG. 2, a portion of the trunnion 200 forms a tapered retention ring providing a tapered retention angle 205 (e.g., 5-60 degrees, etc.) with respect to a main portion of the trunnion 200, which keeps the primary collet 206 secured. The combined forces of the spanner nut 202 and the primary collet 206 form a preload retainer or sleeve applying a radial force on the primary collet 206 to squeeze the root 210 in the trunnion 200. The preload retainer creates a strong clamping force on the threaded retainer collet 204 to retain the root 210 and prevent movement of the root 210 (e.g., react to vibratory load during various phases of operation or flight). As such, the example assembly of FIG. 2 provides a preload retainer, which introduces additional radial force (e.g., through compression achieved by the primary collet 206 and the spanner nut 202) to retain the root 210 in its socket.

The example assembly of FIG. 2 can also be configured with the primary collet 206 and spanner nut 202 in a lowered position on the trunnion. In the lowered position, the primary collet 206 and the spanner nut 202 do not yet provide a radial force to compress the primary collet 206 to retain the root 210 of the blade 215 with respect to the trunnion 200. As shown in the example of FIG. 2, the spanner nut 202 is positioned (e.g., screwed into place, etc.) to exert an upward force on the primary collet 206 with the tapered retention angle 205 (e.g., at a taper angle of 5-60 degrees) to exert a radial preloading force to hold the root 210 in the primary collet 206 and the trunnion 200.

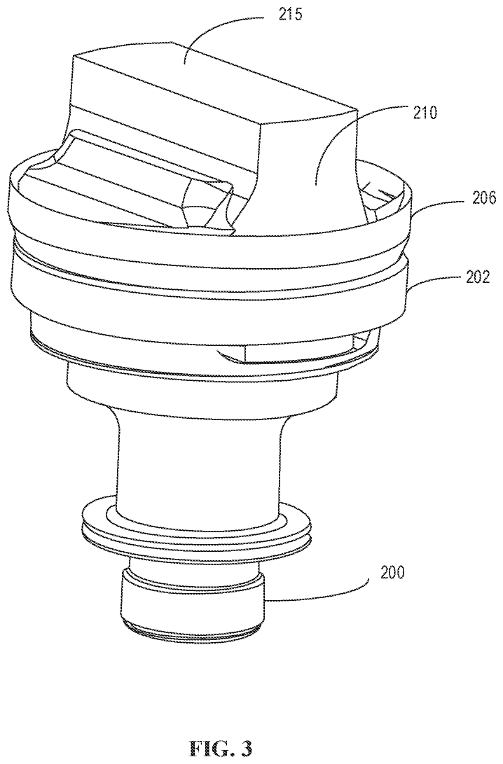

FIG. 3 illustrates another example view of the primary collet preloading retainer of FIG. 2. The example perspective view of FIG. 3 depicts the preload retainer formed of the primary collet 206, which combines forces with the spanner nut 202 to form a preload retainer or sleeve applying a radial force on the primary collet 206 to squeeze the root 210 in the trunnion 200 visible in the cross-sectional view of FIG. 2. The primary collet 206 is positioned above the spanner nut 202. The combined forces of the primary collet 206 and the spanner nut 202 provide a radial preloading force to hold the root 210 in the primary collet 206 and the trunnion 200.

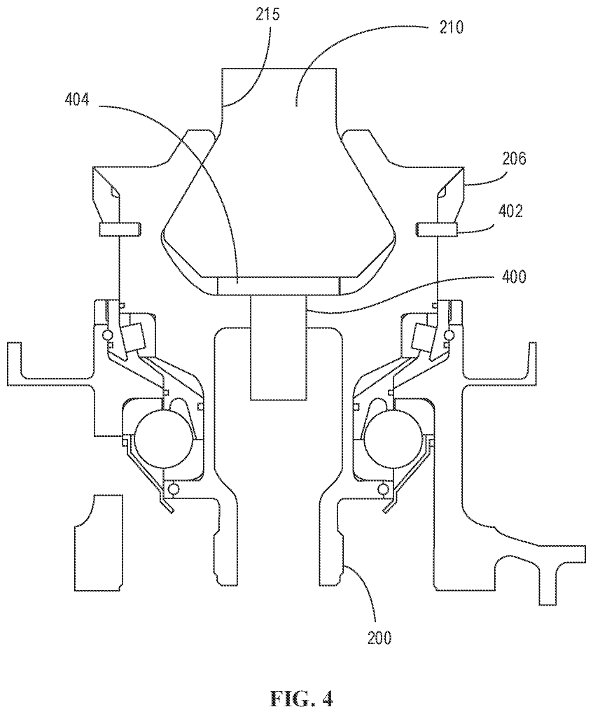

FIG. 4 illustrates another example preload retainer implemented as an example blade and socket configuration using ram loading to secure the blade 215 in the trunnion 200. The configuration of FIG. 4 secures the rotor blade 215 by the root 210, which can be shaped in multiple configurations such as a dovetail as illustrated. The root 210 is held in place inside the trunnion 200, which is a shaft that can position and support the root 210. The trunnion 200 holds the root in place using a preload retainer, which includes a lock ring 402 and the primary collet 206. FIG. 4 shows a cross section in which a ram bolt 400 provides an upward axial force on the root 210. The lock ring 402 and primary collet 206 then push down on the root 210, which creates a strong clamping force on the root 210 to keep the root 210 inside the socket formed by the trunnion 200. FIG. 4 shows that the primary collet 206 encircles the trunnion 200 above the lock ring 402. The visible portion of the primary collet 206 shows the visible part of the cross section that would encircle the trunnion 200.

In certain examples, the configuration of FIG. 4 includes an expanding spacer 404 to generate additional axial force on the root 210 to maintain a position of the root 210 seated with respect to the trunnion 200. The example configuration of FIG. 4 uses a combination of the expanding spacer 404 and the ram bolt 400 to exert an axial force on the root 210 while the lock ring 402 can apply a radial force with respect to the root 210. The combination of forces keeps the root 210 seated in the socket formed by the trunnion 200. The expanding spacer 404 is loaded to lightly seat blade pressure faces prior to loading a lock ring 402 and a primary collet 206. The example assembly of FIG. 4 can also be configured with the ram bolt 400 in a lowered position on the trunnion 200. The ram bolt 400 can be lowered and the lock ring 402 can be removed. Without the lock ring 402 and without the upward axial force of the ram bolt 400, the primary collet 206 rests lower on the trunnion 200 and does not provide a clamping and/or squeezing (e.g., radial) force around the root 210 in the socket formed by the trunnion 200.

As such, FIG. 4 discloses an example preloading or retention apparatus using the primary collet 206 with a lock ring 402 combined with the ram bolt 400 and expanding spacer 404 to retain the root 210 of a blade 215 in the trunnion 200.

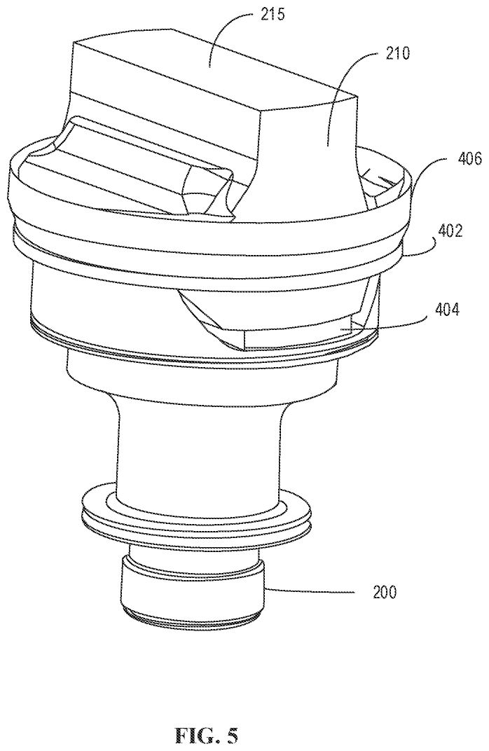

FIG. 5 illustrates another example view of the ram loading preloading retainer of FIG. 4. The example perspective view of FIG. 5 depicts a preloading or retention apparatus using the primary collet 206 with the lock ring 402 combined with the ram bolt 400 (not visible in FIG. 5) and expanding spacer 404 to retain the root 210 of a blade 215 in the trunnion 200. The combined forces of the primary collet 206 and the lock ring 402 provide an axial force on the root 210 in the socket formed by the trunnion 200 in combination with the ram bolt 400 and expanding spacer 404 providing a radial force on the root 210 formed by the trunnion 200.

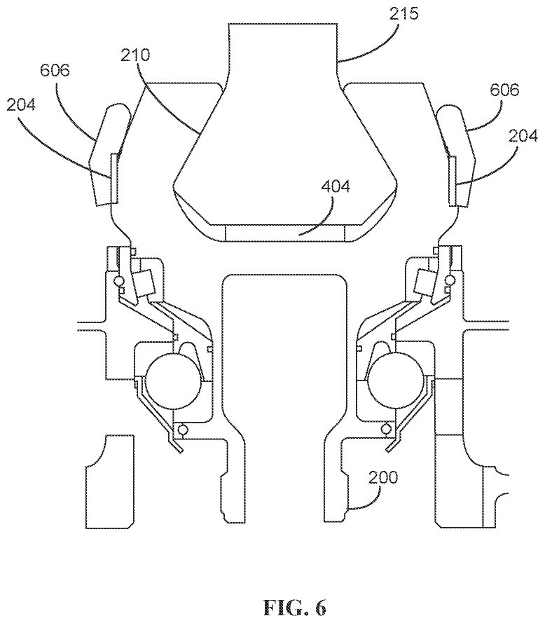

FIG. 6 illustrates an example cross section of another implementation of a preload retainer using a primary collet. In the example of FIG. 6, the root 210 (e.g., dovetail root, conical root, etc.) is held in place inside the trunnion 200 using a primary collet 606. The primary collet 606 in the example of FIG. 6 is a spanner nut that provides a downward force to create a strong clamping force on an upper angled surface of the trunnion 200. FIG. 6 shows a cross section in which the primary collet 606 is shown encircling the trunnion 200. The primary collet 606 includes a threaded retainer collet 204 and is positioned in the angled surface such that the primary collet 606 is threaded on the threaded retainer collet 204 portion on the trunnion 200, for example. The primary collet 606 applies a radial force to squeeze the trunnion 200 to generate a clamping force to keep the root 210 in place with respect to the trunnion 200. The expanding spacer 404 is loaded to lightly seat blade pressure faces prior to loading a primary collet 606.

As such, FIG. 6 discloses an example preloading or retention apparatus using a multi-part collet 204, 606 on an upper angled surface of the trunnion 200 to retain the root 210 of the blade 215 in the trunnion 200. The multi-part collet 204, 606 includes a threaded retainer collet 204 and a primary collet 606. The threaded retainer collet 204 serves as a preload retainer to hold the root 210 in place inside the trunnion 200.

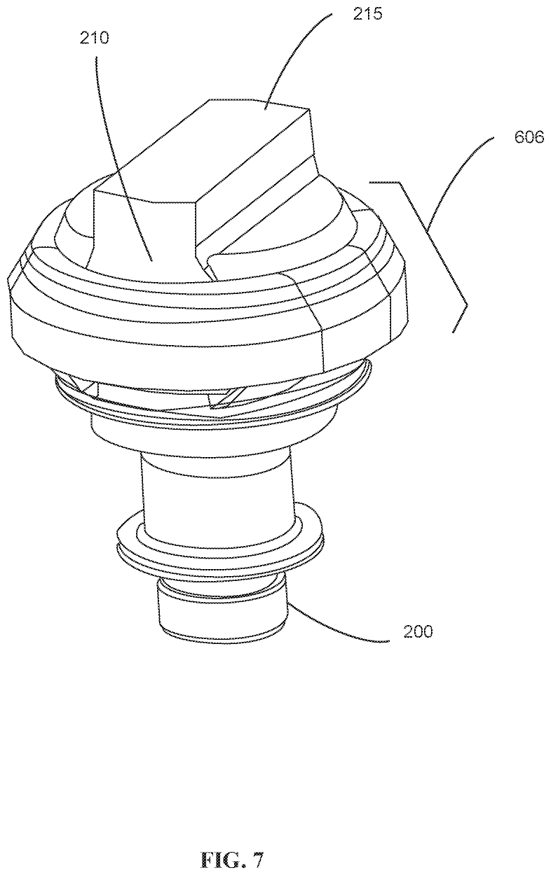

FIG. 7 illustrates another example view of the collet preloading retainer of FIG. 6. The example perspective view of FIG. 7 depicts a preload retainer formed of a primary collet 606. The primary collet 606 provides a radial force causing the trunnion 200 to squeeze around the root 210 to create a strong clamping force to keep the root 210 in place with respect to the trunnion 200.

As such, FIG. 7 discloses an example preloading or retention retainer using a primary collet to provide a radial force to retain the root 210 of the blade 215 in the trunnion 200.

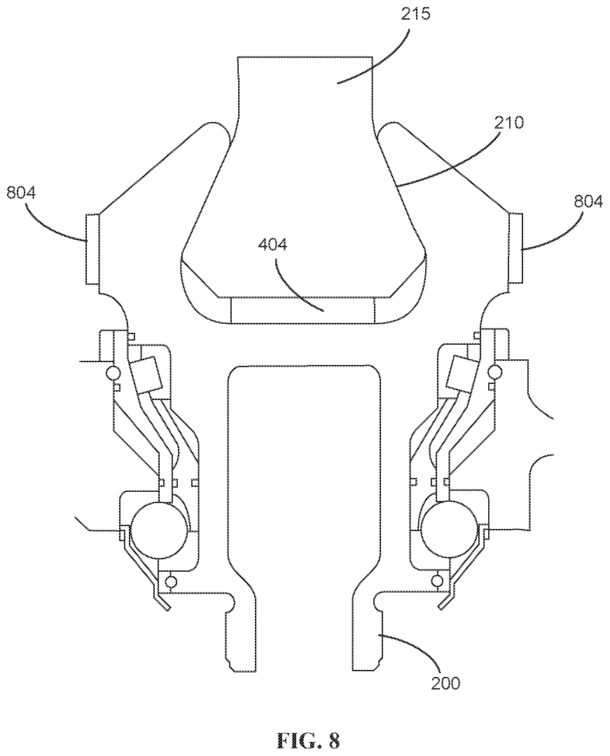

FIG. 8 illustrates a cross section of another example preload retainer using primary collet, an example of which is a belt device 804 for loading. In the example configuration of FIG. 8, the root 210 (e.g., dovetail root, conical root, etc.) is held in place inside the trunnion 200 using a belt device 804. The belt device 804 in the example of FIG. 8 provides a radial force to create a strong clamping force on the trunnion 200. The belt device 804 keeps and/or adds stiffness to the radial clamping using a light weight and secure addition. The expanding spacer 404 is loaded to lightly seat blade pressure faces prior to loading the belt device 804. During high loads, the force needed to operate the engine can cause the root 210 to bend outward. As such, the belt device 804 is added to support the root 210. The belt device provides a radial force and creates a strong clamping force on trunnion 200. The combination of these forces keeps the root 210 seated in the socket formed by the trunnion 200.

As such, FIG. 8 discloses an example preloading or retention apparatus using a belt device 804 to provide a radial force to retain a root 210 of a blade 215 in the trunnion 200.

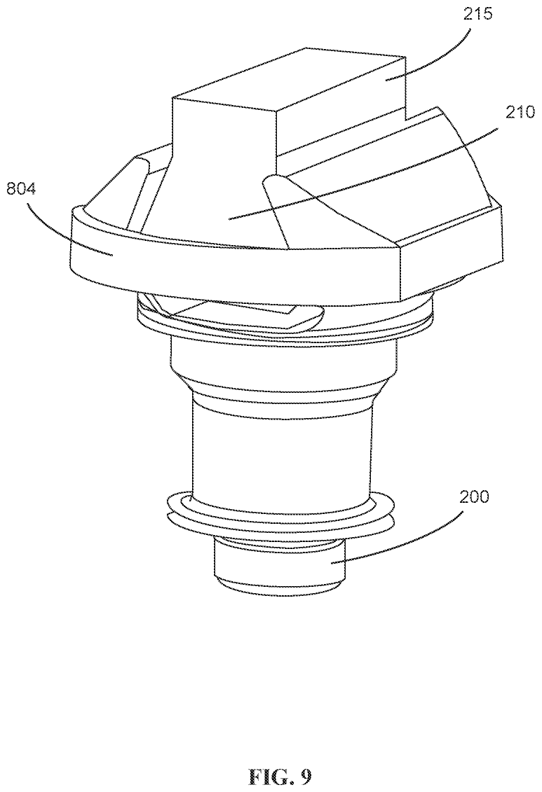

FIG. 9 illustrates another perspective view of the belt device 804 configuration of FIG. 8. As shown in FIG. 9, the belt device 804 surrounds the root 210 seated in the socket formed by the trunnion 200 and provides a radial force and creates a strong clamping force on the trunnion 200.

As such, FIG. 9 discloses an example preloading or retention apparatus using a belt device 804 to provide a radial force to retain a root 210 of a blade 215 in the trunnion 200.

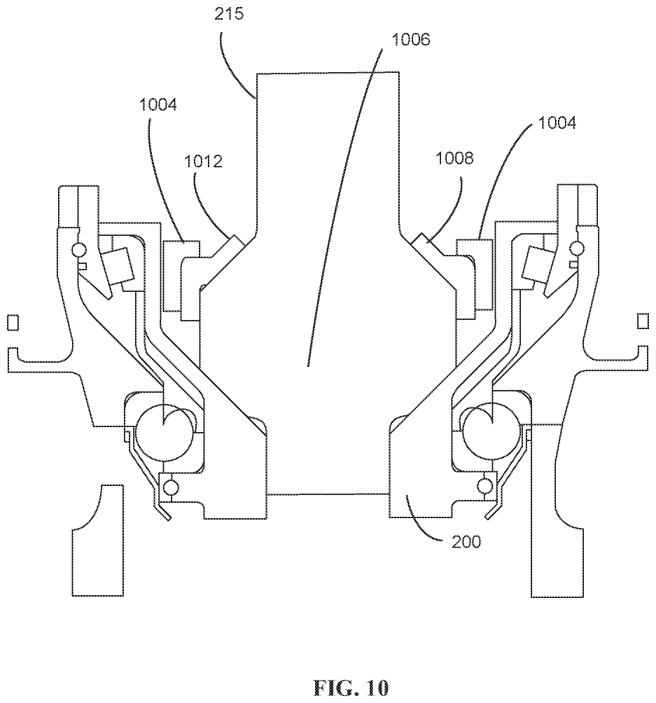

FIG. 10 illustrates an example cross section of another implementation of a preload retainer using a split collet with a double conical root, also referred to as a round root dovetail. In the example of FIG. 10, the root 210 is held in place inside the trunnion 200, using a split collet 1008, 1012 and a spanner nut 1004. The split collet contains two collets that together encircle and/or partially encircle (e.g., with a split or opening between ends of the split collet, etc.) the double conical root 1006 and provide a radial force on the double conical root 1006. The spanner nut 1004 surrounds the split collet 1008, 1012 and provides an additional radial force on the double conical root 1006 seated in the socket formed by the trunnion 200. In the example of FIG. 10, the root is a round root dovetail 1006. The round root dovetail 1006 shown has octagonal faces 1016 that create flat contact surfaces within the socket formed by the trunnion 200. The flat contact surfaces increase the surface area of the faces of the round root dovetail 1006 and create a better seating to have a more secure clamping force on the round root dovetail 1006.

As such, FIG. 10 discloses an example preloading or retention apparatus using a spanner nut 1004 and a split collet 1008, 1012 as a primary collet to provide a radial force to retain the double conical root 1006 of the blade 215 in the trunnion 200.

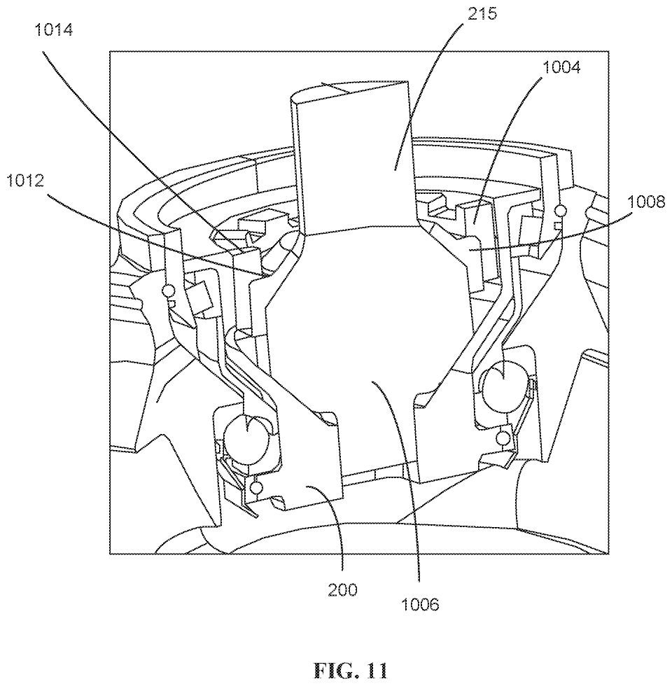

FIG. 11 illustrates another view of the example split collet 1008, 1012, spanner nut 1004 and double conical root 1006 loading configuration of FIG. 10,

As such, FIG. 11 discloses an example preloading or retention apparatus using the spanner nut 1004, split collet 1008, 1012, and round root dovetail 1006 to provide a downward force to retain a root 1006 of a blade 215 in the trunnion 200. In all examples discussed herein, the root 210, 1006 can be removed from the socket formed by the trunnion 200. This is advantageous because it improves serviceability by making removal of the root 210, 1006 able to be accomplished without taking apart the entire engine.

Thus, examples presented disclose implementations of an engine. The examples presented include a means for forming a socket for a root 210, 1006 of a blade 215 such as a trunnion 200. Certain examples provide a means for positioning the root 210, 1006 such as a primary collet 206, 406, 606, 1008, 1012. Certain examples provide a means for encircling the primary collet such as a preload retainer 202, 204, 606, 1004. Certain examples provide a means for encircling the primary collet such as a lock ring 402. Certain examples provide a means for encircling the collet such as a threaded retainer collet 204. Certain examples provide a means for encircling the collet such as a belt device 804. Certain examples provide a means for encircling the trunnion 200 such as split collet 1008, 1012. Thus, examples presented disclose implementations of radial preload retainers to provide radial forces on the root inside the trunnion to assist and maintain blade seating during operation of the engine. FIG. 2-5 each show an example configuration where the preload retainer radially loads a blade's axial dovetail using a radial force. FIG. 2-3 use a spanner nut and collet combination to achieve an upward radial force on the trunnion to clamp on the root of the blade. FIG. 4-5 use a spanner nut with a lock ring and a ram bolt combination to achieve a radial and axial force on the trunnion to clamp on the root of the blade.

FIG. 6-7 each show an example configuration where the preload retainer radially loads a blade's axial dovetail using a downward radial force. FIG. 6-7 use a spanner nut, that is threaded downwards around a trunnion to accomplish the downward force on the trunnion to clamp on the root of the blade.

FIG. 8-9 each show an example configuration where the preload retainer radially loads a blade's axial dovetail using a radial compression force. FIG. 8-9 use a belt device to accomplish the radial compression force on the trunnion to clamp on the root of the blade.

FIG. 10-11 each show an example configuration where the preload retainer radially loads a blade's double conical root, also called round root dovetail using a downforce radial force in combination with the round root dovetail containing that has octagonal faces 1016 that create flat contact surfaces to create pressure faces for a better contact and seating inside the trunnion to clamp on the root of the blade.

Thus, all example configurations discussed above provide a radial preload retainer to provide additional force on the trunnion to clamp on the root of the blade and retain its position with respect to the trunnion.

Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Additionally, although individual features may be included in different examples or claims, these may possibly be combined, and the inclusion in different examples or claims does not imply that a combination of features is not feasible and/or advantageous.

From the foregoing, it will be appreciated that example methods, apparatus and articles of manufacture have been disclosed that improve design and configuration of a blade in a slot. Certain examples improve positioning and maintenance of positioning of the blade in the slot when subjected to force.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

Further aspects of the invention are provided by the subject matter of the following clauses:

The engine including a trunnion forming a socket for a root of a blade, a primary collet positioning the root with respect to the trunnion, and a radial preload retainer at least partially encircling the primary collet and applying a radial force with respect to the primary collet to support the primary collet positioning the root with respect to the trunnion.

The engine of any preceding clause, wherein the preload retainer at least partially encircling the primary collet includes at least one of a spanner nut, a lock ring, a belt device, or a threaded retainer collet.

The engine of any preceding clause, wherein the preload retainer at least partially encircling the primary collet is a first preload retainer, and further including a second preload retainer that applies an axial force to support the primary collet positioning the root with respect to the trunnion.

The engine of any preceding clause, wherein the second preload retainer includes at least one of a ram bolt or an expanding spacer.

The engine of any preceding clause, wherein the root includes a round root dovetail, and wherein the preload retainer includes at least one of a spanner nut, a lock ring, a belt device, or a threaded retainer collet.

The engine of any preceding clause, wherein the socket formed by the trunnion includes octagonal faces forming flat contact surfaces in the socket to seat and exert a clamping force on the root.

The engine of any preceding clause, wherein the preload retainer allows for removal of the root from the socket formed by the trunnion.

The engine of any preceding clause, wherein the trunnion includes a tapered retention angle of between 5 and 60 degrees.

The engine of any preceding clause, wherein the root is a double conical root, the primary collet is a split collet, and the preload retainer is a spanner nut.

The engine of any preceding clause, wherein the primary collet includes a split collet.

A rotor assembly for a blades of an engine comprising, a primary collet positioning a root with respect to a trunnion, the trunnion forming a socket for the root, and a radial preload retainer encircling the primary collet and applying a radial force with respect to the primary collet to support the primary collet positioning the root with respect to the trunnion.

The rotor assembly of any preceding clause, wherein the preload retainer includes at least one of a spanner nut, a lock ring, a belt device, or a threaded retainer collet.

The rotor assembly of any preceding clause, wherein the preload retainer is a first preload retainer, and further including a second preload retainer that applies an axial force to support the collet positioning the root with respect to the trunnion.

The rotor assembly of any preceding clause, wherein a second preload retainer includes at least one of a ram bolt or an expanding spacer.

The rotor assembly of any preceding clause, wherein the root includes a round root dovetail, and wherein the preload retainer includes at least one of a spanner nut, a lock ring, a belt device, or a threaded retainer collet.

The rotor assembly of any preceding clause, wherein the preload retainer reacts an asymmetric propeller loading on the root of the blade.

The rotor assembly of any preceding clause, wherein the socket formed by the trunnion includes octagonal faces forming flat contact surfaces in the socket to seat and exert a clamping force on the root.

The rotor assembly of any preceding clause, wherein the rotor assembly is included in an open rotor engine.

A blade retention apparatus including a means for forming a socket for a root of a blade, a means for positioning the root in the socket, and a means for encircling the means for positioning and applying a radial force with respect to the means for positioning to maintain the root in the socket.

The blade retention apparatus of any preceding clause, wherein further includes a means for applying an axial force with respect to the means for positioning.

A turbofan including a trunnion forming a socket for a root of a blade, a primary collet positioning the root with respect to the trunnion, and a radial preload retainer at least partially encircling the primary collet and applying a radial force with respect to the primary collet to support the primary collet positioning the root with respect to the trunnion.

The turbofan of any preceding clause, wherein the preload retainer that encircles the primary collet and applies a radial force to help retain the root in position with respect to the primary collet and trunnion includes a spanner nut.

The turbofan of any preceding clause, wherein the preload retainer that encircles the primary collet and applies a radial and axial force to help retain the root in position with respect to the primary collet and trunnion includes the lock ring and ram bolt.

The turbofan of any preceding clause, wherein the preload retainer that encircles the primary collet and applies a radial force to help retain the root in position with respect to the primary collet and trunnion includes the spanner nut threaded on the threaded retainer collet.

The turbofan of any preceding clause, wherein the preload retainer that encircles the primary collet and applies a radial and axial force to help retain the root in position with respect to the primary collet and trunnion includes the belt device and expanding spacer.

The turbofan of any preceding clause, wherein the preload retainer that encircles the primary collet and applies a radial force to help retain the root in position with respect to the primary collet and trunnion includes the spanner nut and split collet with a round root dovetail.

The turbofan of any preceding clause, wherein a trunnion forming a socket for a root of a blade, a primary collet positioning the root with respect to the trunnion, a radial preload retainer encircling the collet and applying a radial force with respect to the primary collet to support the primary collet positioning the root with respect to the trunnion.

The turbofan of any preceding clause, wherein the preload retainer includes at least one of a spanner nut, a lock ring, a belt device, a split collet.

The turbofan of any preceding clause, wherein the preload retainer is a first preload retainer, and further including a second preload retainer that applies an axial force to support the primary collet positioning the root with respect to the trunnion.

The turbofan of any preceding clause, wherein the second preload retainer includes at least one of a ram bolt or an expanding spacer.

The turbofan of any preceding clause, wherein the root includes a round root dovetail, and wherein the preload retainer includes at least one of a spanner nut, a lock ring, a belt device, or a split collet.

The turbofan of any preceding clause, wherein it includes octagonal faces that create flat contact surfaces within the socket formed by the trunnion to create a secure seating and strong clamping force on the round root dovetail.

The turbofan of any preceding clause, wherein the preload retainer allows for removal of the root from the socket formed by the trunnion.

The turbofan of any preceding clause, wherein the trunnion includes a tapered retention angle of between 5 and 60 degrees.

We claim:

1. An engine comprising:
a trunnion forming a socket for a root of a blade;
a primary collet positioning the root with respect to the trunnion; and
a radial preload retainer at least partially encircling the primary collet and applying a radial force with respect to the primary collet to support the primary collet positioning the root with respect to the trunnion.

2. The engine of claim 1, wherein the radial preload retainer includes at least one of a spanner nut, a lock ring, a belt device, or a threaded retainer collet.

3. The engine of claim 1, wherein the radial preload retainer is a first preload retainer, and further including a second preload retainer that applies an axial force to support the primary collet positioning the root with respect to the trunnion.

4. The engine of claim 3, wherein the second preload retainer includes at least one of a ram bolt or an expanding spacer.

5. The engine of claim 1, wherein the root includes a round root dovetail, and wherein the radial preload retainer includes at least one of a spanner nut, a lock ring, a belt device, or a threaded retainer collet.

6. The engine of claim 1, wherein the socket formed by the trunnion includes octagonal faces forming flat contact surfaces in the socket to seat and exert a clamping force on the root.

7. The engine of claim 1, wherein the radial preload retainer allows for removal of the root from the socket formed by the trunnion.

8. The engine of claim 1, wherein the trunnion includes a tapered retention angle of between 5 and 60 degrees.

9. The engine of claim 1, wherein the root is a double conical root, the primary collet is a split collet, and the radial preload retainer is a spanner nut.

10. The engine of claim 1, wherein the primary collet includes a split collet.

11. A rotor assembly for a blades of an engine comprising:
a primary collet positioning a root of a blade with respect to a trunnion, the trunnion forming a socket for the root; and
a radial preload retainer encircling the primary collet and applying a radial force with respect to the primary collet to support the primary collet positioning the root with respect to the trunnion.

12. The rotor assembly of claim 11, wherein the radial preload retainer includes at least one of a spanner nut, a lock ring, a belt device, or a threaded retainer collet.

13. The rotor assembly of claim 11, wherein the radial preload retainer is a first preload retainer, and further including a second preload retainer that applies an axial force to support the collet positioning the root with respect to the trunnion.

14. The rotor assembly of claim 11, wherein a second preload retainer includes at least one of a ram bolt or an expanding spacer.

15. The rotor assembly of claim 11, wherein the root includes a round root dovetail, and wherein the preload retainer includes at least one of a spanner nut, a lock ring, a belt device, or a threaded retainer collet.

16. The rotor assembly of claim 11, wherein the radial preload retainer reacts an asymmetric propeller loading on the root of the blade.

17. The rotor assembly of claim 11, wherein the socket formed by the trunnion includes octagonal faces forming flat contact surfaces in the socket to seat and exert a clamping force on the root.

18. The rotor of assembly claim 11, wherein the rotor assembly is included in an open rotor engine.

19. A blade retention apparatus comprising:
a means for forming a socket for a root of a blade;
a means for positioning the root in the socket; and
a means for encircling the means for positioning and applying a radial force with respect to the means for positioning to maintain the root in the socket.

20. The blade retention apparatus of claim 19, further including:
means for applying an axial force with respect to the means for positioning.
